(19) United States
(12) Patent Application Publication
(10) Pub. No.: US 2019/0325681 A1
(43) Pub. Date: Oct. 24, 2019

(54) GARAGE DOOR OPERATOR WITH CAMERA

(71) Applicant: ASSA ABLOY ENTRANCE SYSTEMS AB, Landskrona (SE)

(72) Inventors: David P. Bresson, Pfafftown, NC (US); Vickie Chan Lents, Winston-Salem, NC (US)

(21) Appl. No.: 15/958,091

(22) Filed: Apr. 20, 2018

(51) Int. Cl. G07C 9/00; E05F 15/681; E05F 15/40; H04N 7/18

(52) U.S. Cl. CPC G07C 9/00563; E05B 37/0072; E05F 15/40; H04N 7/183; E05Y 2400/32; E05Y 2400/44; E05Y 2400/85; E05Y 2201/644; E05Y 2201/43; E05Y 2900/106; E05Y 2900/132; E05Y 2400/654; E05Y 2400/664; E05Y 2400/512; E05F 15/681

(57) ABSTRACT

Disclosed is an operator for a garage door including one or more cameras. The operator consists of a motor, a traction mechanism connected with the motor, a door connected with the traction mechanism, wherein operation of the motor causes the traction mechanism to open and/or close the door and wherein the door is located in a doorway, a controller operatively connected with the motor to open and close the door, an imaging system connected with the controller and positioned to collect image data, and a communication system connected with the controller, the communication system adapted to send data, including image data, from the controller and to communicate command signals to the controller, wherein image data is sent to a remote user device and command signals are received from the remote user device. The controller is also connected to one or more lock actuators that can lock and unlock the garage door as well as one or more man doors. Image data is used to control operation of the door, to lock and unlock the door in response to event, such as the delivery of a package, and lock and unlock the man doors to allow access to a dwelling and to secure the dwelling.

### BACKGROUND

### Field

The present disclosure relates to motorized door operators that are actuated remotely and more particularly, to door operators equipped with an imaging system to capture images proximate to door, communicate such images to a user, and operate the door in response to the images.

### Description of the Related Art

Garage doors are often equipped with motorized operators that allow a user to remotely open and close the door using a radio frequency control device. Door operator may interface with computer networks, such as the Internet to allow a user to communicate remotely with the operator, for example, to alert the user that the garage door is open or closed. The user can then send a signal to open and close the door remotely, for example, using a smartphone connected with the operator via the Internet. Some of these door operators rely on signals from sensors on the door or from encodes on the opener mechanism to provide data indicating the position of the door with respect to the doorway. Thus, a door operator may show that the door mechanism is in the fully closed position. Such systems, however, may not give the user assurance that the premises are actually secure and that the door is fully intact.

Some garage door operators allow users to remotely operate doors to open the door at a predetermined time, for example, a time when a delivery person is expected to arrive to deliver a package. These operators may not allow a user to know that a delivery person or a visitor has arrived at an unexpected time. Such system may also not allow a user to confirm that a purported delivery person is indeed authorized to enter the garage. Such systems may not confirm that an expected package has arrived and allow the package to be delivered inside the premises autonomously without requiring user interaction.

In addition to a garage door, dwellings typically have a number of other doors, e.g., front, back, and side doors (so-called “man doors”). In many homes, an interior man door is provided between the garage and the house. These man doors may include a deadbolt or other locking mechanism to secure the dwelling. To enter the dwelling through the garage, a user must first operate the garage door, perhaps using a radio frequency device from within a vehicle, and then use a key to unlock the interior man door. In this situation, since the user has gained access via the garage door, his authority to enter the dwelling may have been established. Requiring the user to perform a separate operation to unlock the interior door may not be necessary to assure security, and instead adds complexity and inconvenience for the user. Likewise, when a user leaves the dwelling, to assure that the dwelling is secure, the user may need to separately lock both the man door and the garage door.

Thus, there is a need for a garage door operator that allows a user at a remote location to be assured that the door is closed and that the integrity of the door and the premises are secure. There is also a need for a garage door operator that allows a remote user to determine that a person seeking to gain access to the garage is authorized to do so. There is also a need for a garage door operator that is integrated with the locking mechanism of other doors, including man doors, to conveniently allow authorized users access to a dwelling next to the garage and to conveniently secure the garage and the dwelling when the user leaves. There is also a need for an operator that enables a user to remotely allow access to a garage area, for example, to accept delivery of a package, but maintain the security of a dwelling connected with the garage area.

### SUMMARY

The present disclosure relates to apparatuses and methods to address these and other difficulties.

According to one embodiment there is provided a door operator comprising: a motor; a traction mechanism connected with the motor; a door connected with the traction mechanism, wherein operation of the motor causes the traction mechanism to open and/or close the door and wherein the door is located in a doorway; a controller operatively connected with the motor to open and close the door; an imaging system connected with the controller and positioned to collect image data; and a communication system connected with the controller, the communication system adapted to send data, including image data, from the controller and to communicate command signals to the controller, wherein image data is sent to a remote user device and command signals are received from the remote user device. The image data may be a video stream of the doorway. The imaging system may comprise two or more cameras and/or a camera positioned to capture an image of objects outside the doorway. The operator may comprise a housing surrounding the motor and the imaging system may comprise a camera physically mounted on the housing and/or a camera mounted on a wall.

According to a further embodiment the controller detects that the door is fully open and fully closed and wherein, when a command to open or close the door is received by the communication system, a video stream of the doorway is communicated to the user until the door reaches a fully open or fully closed position. According to another embodiment, the controller determines, based on the image data, that the door is in a damaged state and does not operate the motor. According to another embodiment the operator comprises a presence detector for detecting the presence of a person or vehicle proximate to the doorway and wherein the controller sends a signal to the user in response to a signal from the presence detector.

According to another embodiment, there is provided a door operator system comprising: a door operator comprising: a motor; a traction mechanism connected with the motor; a door connected with the traction mechanism, wherein operation of the motor causes the traction mechanism to open and/or close the door and wherein the door is located in a doorway; a controller operatively connected with the motor to open and close the door; an imaging system connected with the controller and positioned to collect one or more images of a region proximate to the doorway; and a communication system connected with the controller, the communication system adapted to send data from the controller and to communicate command signals to the controller, wherein the data includes the image, and wherein the data is sent to a remote user and one or more command signals are received from the remote user; and a remote user device, the remote user device receiving the data and sending the command signals to the operator. The imaging system may include a plurality of cameras and wherein the images are video data streams. The video streams may be communicated to the remote user device via the communication system.

According to another embodiment the controller is operatively connected with one or more remote lock actuators and where a first lock actuator is adapted to actuate a lock on the door to lock or unlock the door. According to another embodiment, the system further comprises a man door, the man door comprising a man door lock and a second lock actuator operatively connected with the controller, wherein a signal from the controller causes the second lock actuator to lock or unlock the man door lock. The images may include an image of the man door. The data may include an image of a credential document, the credential document being associated with an authorized person, and wherein the controller opens the door in response to the image of the credential document. According to another embodiment the remote user device communicates an authorization time period to the controller, and wherein the controller opens the door in response to the image of the credential document only within the authorization time period. According to another embodiment after the controller opens the door the controller waits for a delay period and then closes the door.

According to another embodiment, the system further comprises a presence detector for detecting the presence of a person or vehicle proximate to the doorway and wherein the controller sends a signal to the user in response to a signal from the presence detector.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a perspective view of the interior of a garage including a garage door connected with a door operator according to an embodiment of the disclosure;

FIG. 2 is a schematic diagram illustrating a door operator according an embodiment of the disclosure; and

FIG. 3 is a perspective view of the outside of a garage door connected with the door operator of FIGS. 1 and 2.

### DETAILED DESCRIPTION

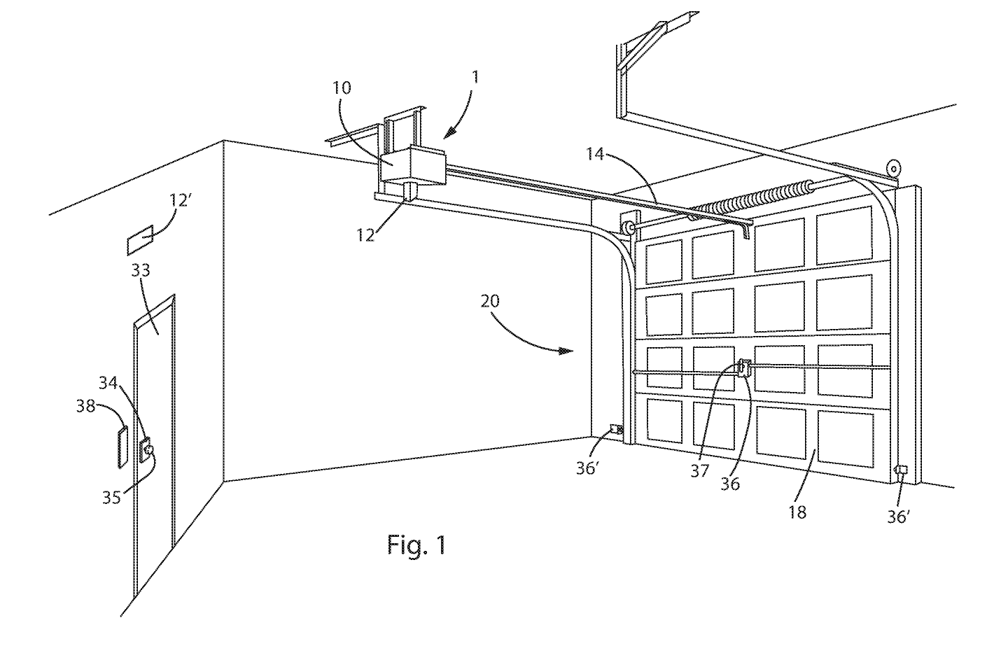

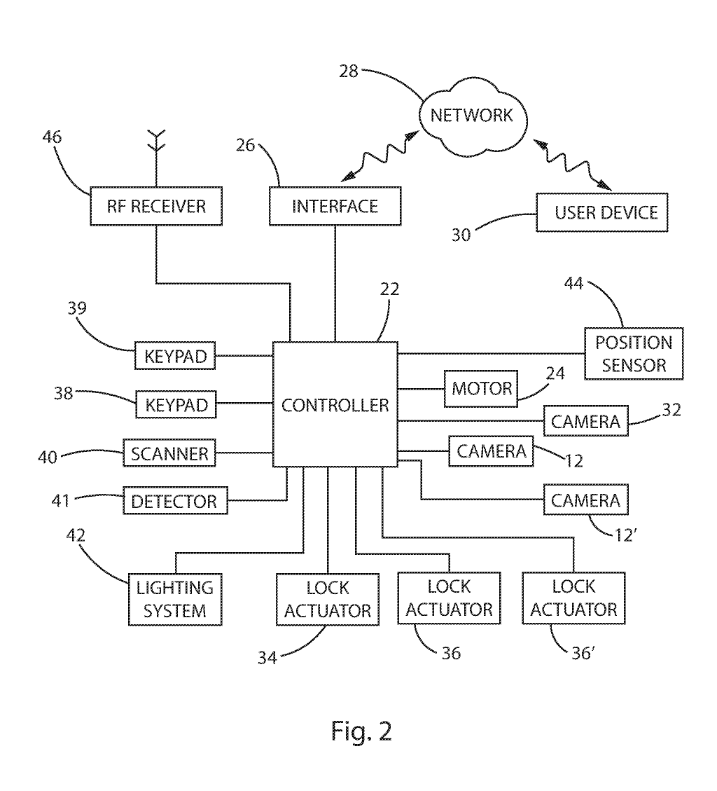

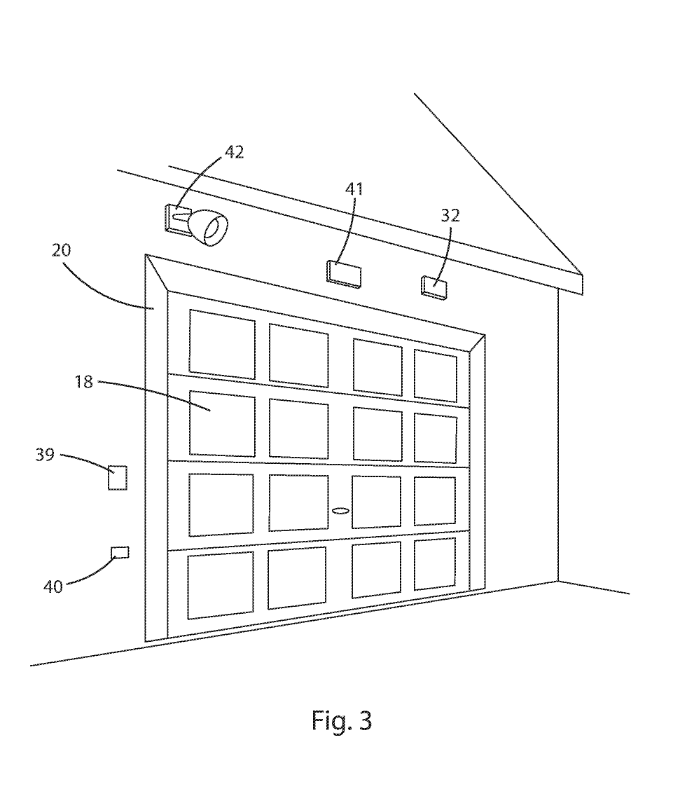

FIG. 1 shows a garage door 18 installed in the doorway 20 of a garage and connected with an operator 1 according to an embodiment of the disclosure. FIG. 2 shows a schematic of components that comprise the operator 1. FIG. 3 is a perspective view of the exterior of the garage.

Operator 1 includes a housing 10 surrounding a motor 24 that drives door 18 to open and closed via traction mechanism 14. Motor housing 10 includes a controller 22, shown in FIG. 2, that controls motor 24 to move the door 18 between an open and a closed position.

Cameras 12, 12′, and 32 are connected with the controller 22. The connection between the cameras and the controller 22 may be by a hard-wired electrical circuit or by a wireless connection, for example, by a BlueTooth™ link. As shown in FIG. 1, camera 12 is mounted on the housing 10 itself. According to one embodiment, camera 12 is positioned to capture an image of the inside of the garage doorway. Camera 12 may be equipped with a wide-angle lens to capture the full area of the doorway in a single image. Alternatively, or in addition to camera 12, camera 12′ is mounted elsewhere in the garage facing door 18, for example, on a wall or ceiling of the garage. According to one embodiment, the locations of cameras 12, 12′ are chosen to provide an unobstructed view of door 18 as it opens and closes. Thus, camera 12′ may be positioned at location that provides a view of the doorway that is not obstructed when a vehicle is parked in the garage. Alternatively, or in addition to cameras 12 and 12′, additional cameras may be provided and the images from these cameras may be joined in a composite image that shows an unobstructed view of the doorway, despite the presence of a vehicle in the garage. In addition, other cameras may be provided to provide view of other areas of the garage and/or a dwelling associated with the garage.

According to a further embodiment, camera 32 is mounted on an exterior wall of the garage. Exterior camera 32 may be positioned to capture images of vehicles, persons, or objects located outside of the doorway. In addition to exterior camera 32, other cameras may be positioned outside the garage and connected with controller 22. These may include cameras that capture images of the garage door from the outside or the capture images of other areas outside the garage, for example, the front door of the house.

As shown in FIG. 2, interface 26 is connected with controller 22. Controller 22 communicates with other devices via interface 26 and a computer network 28. In the embodiment shown in FIG. 2, interface 26 communicates wirelessly, for example, via a WiFi router, with other devices via the Internet. Alternatively, or in addition to wireless communication, controller 22 may communicate with other devices on network 28 via a local area network, a wide area network, or the like.

Also connected with network 28 is a remote user device 30, which may be a computer tablet, smartphone, desktop computer, or other computing device operated by an authorized user, such as the homeowner. The connection between user device 30 and controller 22 allows data, including image data, to be communicated to the user device and commands, including commands to open and close the door, activate camera, to lock and unlock door, and to turn on and off lights, from the user device to the controller. The user may provide identifying information, such as a password or fingerprint scan to device 30 to assure that only an authorized user is operating device 30.

Position sensor 44 is connected with motor 24 and/or traction mechanism 14 and provides information to controller 22 about the current position of door 18. According to one embodiment, position sensor 44 is an encoder connected with the drive shaft of motor 24. Based on information from position sensor 44, the controller determines whether door 18 is full open or fully closed. According to another embodiment, controller 22 also monitors current supplied to motor 24. In the event there is an obstruction preventing door 18 and/or traction mechanism 14 from moving, controller 22 detects a change in motor current as a result of the motor being stalled. In such an event, controller 22 will set an error condition. According to one embodiment, this error condition is communicated to the user device 30 via network 28 alerting the user that the system requires servicing.

In addition to controlling the operation of door 18 using user device 30, as will be explained below, a user can operate the door using a conventional RF transmitter. RF receiver 46 is connected with controller 22. RF receiver 46 receives radio frequency signals from a transmitter such as a conventional garage door opener transmitter (not shown). RF receiver 46 or controller 22 authenticates signals received from the RF transmitter, for example, by comparing the signal to a predefined pass code or encryption key to assure that the transmitter is the one assigned to operate the door. According to one embodiment, when a command is received from an authenticated RF transmitter (i.e., a transmitter with a known pass code), controller 22 sends a signal to user device 30 alerting the user that someone is attempting to operate the door. According to one aspect of this embodiment, the user may send a command preventing the door from operating, for example, because an authenticated transmitter has been lost or stolen. According to another embodiment, a signal is sent to the user device 30 to alert the user that the door has been actuated and to request authorization to open the door. According to a further embodiment, a video stream from the exterior camera 32 is provided to the user showing the person operating the transmitter and the user sends a command to authorize opening door 18 after confirming the identity of the person operating the transmitter. According to a still further embodiment, signals received by the RF transmitter take precedence over commands received via network 28, for example, under circumstances where network 28 malfunctions so that a network failure will not prevent a user with an authorized transmitter from gaining access to the premises.

A user operating device 30 can enter a command to open and/or close door 18 remotely. That command is communicated to controller 22 via network 28 and interface 26, causing the controller to activate motor 24 to move the door. According to one embodiment of the disclosure, when the controller causes the door to open or close, the controller also causes one or more of the interior cameras 12, 12′ to capture images of door 18. These images are communicated via interface 26 and network 28 to the user's device 30 and an image of the door opening and/or closing is provided to the user. The images may be one or more still images showing the door fully closed or fully open, as determined by position sensor 44, or the images may be a video stream showing an image of the door moving into the close or open position.

According to another embodiment, the user sends a command from device 30 to close the door 18. Again, cameras 12, 12′ are activated to capture video images of the doorway. If the user sees that the doorway is obstructed, the user can send a command to halt and/or reverse the closing motion of the door. Alternatively, controller 22 or another computer system, such as device 30, monitors the image captured by the cameras and determines, from computer analysis of the image, that the doorway is block. If so, controller 22 does not cause motor 24 to close the door until the object blocking the doorway is removed. According to another embodiment, if the blockage of the doorway occurs while the door is closing, the computer system halts and/or reverses the closing motion of the door automatically. In the event there is no blockage of the doorway, images showing the closing of the door is displayed on the user device 30, giving the user assurance that the door is fully and safely closed.

According to another embodiment, the user sends a command via device 30 to activate one or more of cameras 12, 12′, 32 without opening or closing door 18. For example, when a user wishes to determine the security of the interior or exterior of the garage, the user can activate one or more of the cameras and be provided with a live video stream of the premises. According to a further embodiment, the program running on device 30 allows the user to send a command to controller 22 to activate lighting system 42 to turn on or turn off lights.

According to one embodiment, a detector 41 such as a motion sensor, electric eye, pressure sensor, sound sensor or the like may be provided on the exterior side of doorway 20. Controller 22 monitors the detector and, in response to detecting the presence of a person or vehicle, camera 32 is activated and an image is captured. According to another embodiment, controller 22 monitors exterior camera 32 and, when the image of a person, vehicle, or other object is detected, controller 22 sends an alert signal to the user's device 30. An alert is sent to the user device 30 and image data from the exterior camera 32 is provided to the user device 30 to allow the user to confirm the identity of the person in the proximity of the doorway 20.

According to another embodiment, controller 22 controls multiple motors 24, each motor connected with a traction mechanism 14 to operate multiple doors 18. Such an embodiment may include additional cameras, keypads, sensors, and the like associated with each of the multiple doors.

FIG. 3 is a view of door 18 from the exterior of the garage. Camera 32 is mounted near the doorway 20. When a vehicle or a person approaches the garage, camera 32 captures an image or a video stream of the area proximate the door. According to one embodiment, controller 22 sends a video stream or a still image showing the vehicle or person to the user device 30 via network 28. If the user determines that the vehicle belongs to a person authorized to access the garage, the user can send a command to open the garage door. Thus, a user can allow a person delivering a package to place the package inside the garage or to allow a trusted visitor access to the garage. After a predetermined time to allow the package to be delivered or for the person to enter the garage, for example, five minutes, controller 22 causes motor 24 to close door 18.

External camera 32 may also detect other indicia, such as a bar code tag 44 on the vehicle operated by an authorized person or entity or on an identity card or badge carried by an authorized person. Again, the user can provide commands to the controller via network 28 to provide and/or deny access to the garage based on the credentials represented by the indicia.

Also connected with controller 22 is a lighting system 42. Lighting system 42 provides illumination to the interior of the garage. Lighting system 42 may also provide illumination to the exterior of the garage or to other locations within a dwelling associated with the garage, for example, walkway lighting.

Also connected with controller 22 is exterior keypad 39. As shown in FIG. 3, exterior keypad 39 may be located to one side of door 18 on the outside wall of the garage. Also connected with controller 22 is scanner 40 located on an exterior wall of the garage, for example, near keypad 39. Scanner 40 may be a laser barcode reader that scans barcode patters such as the MT6222 scanner manufactured by Marson Technology Co., Ltd. Alternatively, camera 39 may function to capture UPC bar codes or QR targets that are decoded by controller 22 or other computer device.

According to a further embodiment, a delivery company wishing to make a delivery to a home equipped with an embodiment of the disclosure can be provided with a delivery key, such as a pass code to enter into keypad 39 that will allow door 18 to open. After a delay of, for example, about 5 minutes, controller 22 causes door 18 to close. This provides a delivery person sufficient time to place the package inside the garage and then closes the door to secure the package inside. According to one embodiment, the delay is programmed by the user via commands sent from the user device 30 to controller 22. According to another embodiment, the delivery person secures the package inside the garage by again entering the delivery key, which causes the operator to close the door 18.

According to a further embodiment, a user authorizes a delivery person or a deliver company to make a delivery, for example, as part of the process of purchasing an item from an on-line retailer. An encryption key is generated by the user device 30 or by another computer system connected with network 28. The encryption key is provided to controller 22. The encryption key is also used to generate a credential document, such as a QR or UPC image that may be printed out by the delivery company or may be provided to the delivery person as an image displayed on a mobile device, for example, a smartphone. To make a delivery, the delivery person presents the credential document to camera 32 or scanner 40. Controller 22 determines whether the scanned document matches the encryption key. If so, the controller opens door 18 to allow the package to be placed inside the garage. For added security, the user may make the authorization associated with the encryption key available for a limited period of time, for example, only for the day or span of hours in a day when the delivery is expected. Once the package is delivered and after a user programmable time delay, for example, about five minutes, controller 22 closes the door 18, securing the delivered package in the garage.

According to one embodiment, a delivery company may pay a fee to an entity that administrates operation of system 1 in order to receive a credential document. The cost to the user or the delivery company to access to a user's garage using the credential document may be made part of the delivery cost and/or may be a license fee to use the system.

According to another embodiment, controller 22 can detect the image of the bar code, QR code or other package indicia on a package being delivered. The controller 22 may also receive package identifying information from the package delivery company via network 28. When a delivery person arrives at the door 18 with a package, camera 32 or scanner 40 provides the package indicia to controller 22. Controller 22 decodes the indicia to determine information about the package to confirm that the package is expected to be delivered based on identifying information provided by the delivery company. If the package is one that is expected to be delivered, controller 22 causes door 18 to open, allowing the delivery person to place the package in the garage. If the package is not expected to be delivered, according to one embodiment, a signal is sent to the user via network 28 to the user device 30 alerting the user to the delivery of an unexpected package and providing the user with an image or a stream of video images from camera 32. The user can decide if the delivery person should be allowed access to deliver the unexpected package and instruct controller 22 to open the door. According to another embodiment, controller 22 determines the identity of the package delivery company based on the identifying information on the package and sends information about the unexpected package to the delivery company, for example, that the package has been rejected.

Also connected with controller 22 are one or more lock actuators 34, 36, 36′. As shown in FIG. 1, actuator 34 operates the lock mechanism 35 of man door 33. Man door 33 may be the door connecting the garage with an adjoining dwelling, or another door of the dwelling (e.g., a front door, a side door, a basement door, and the like). Multiple man doors 33 may each be equipped with an actuator 34, allowing controller 22 to secure multiple entrances to the building. Actuator 36 operates the lock mechanism 37 of garage door 18. Actuators 36′ operate wind load bolt locks on either side of door 18. Wind load bolt locks allow door 18 to be secured against strong winds, for example, in the event of a hurricane. The connection between controller 22 and actuators 34, 36, 36′ may be a hard-wired connection, for example, by an electrical circuit between the controller and the actuators. Alternatively, controller 22 may be connected to actuators 34, 36, 36′ via a wireless link, such as a Bluetooth™ link or controller 22 may communicate with the actuators via the wireless network 28 and interface 26. In response to commands sent from the user device 30, actuators 34, 36, 36′ can be operated remotely to lock and unlock door 18 and any of the man doors 33 equipped with an actuator. According to one embodiment, one or more of cameras 12, 12′ capture an image of lock mechanisms 35, 37 and provide this image to the user via the user device 30. Thus, when the user sends a command to lock a door, the user is provided with visual confirmation that the lock mechanism has been actuated.

Also connected with controller 22 is interior keypad 38. Keypad 38 captures keystrokes entered by a user, for example, to enter a password to allow controller 22 to actuate the lock actuators 34, 36, 36′ and open and/or open and close the door 18. According to one embodiment, interior keypad 38 is located on an interior wall of the garage near man door 33, or at some other location that allows the user to conveniently enter keystrokes to operate the door control system. According to one embodiment, a user enters a predetermined password into keypad 38. In response to a correct password, controller 22 causes actuator 34 to unlock door 33 and/or actuator 36 to unlock door 18 and cause door 18 to open.

According to one embodiment, when controller 22 determines that door 18 is in the fully closed position, the controller causes actuator 36 on door 18 to lock the door. Thus, when door 18 is closed, it is also locked. According to this embodiment, before controller actuates motor 24 to open the door, actuator 36 is commanded to unlock door 18. Wind load bolt lock actuators 36′ may be actuated to lock door 18 at the same time as actuator 36 or may be actuated only in the event of an impending storm.

Controller 22 locks and unlocks man door 33 using actuator 34. Door 33 may be the door connecting the garage with an adjoining dwelling. According to one embodiment, when garage door 18 is opened, controller 22 causes actuator 34 to unlock man door 33, thus allowing a user in a vehicle to enter the garage through garage door 18 and then to enter the adjoining dwelling through man door 33 without having to separately unlock interior man door 33. When door 18 is closed, controller causes actuator 34 to lock man door 33, thus securing the premises. A user-programable delay may be set, for example, about five minutes, between closing door 18 and locking man door 33 to allow a user sufficient time to exit the vehicle and enter the dwelling. According to another embodiment, the user can program controller 22 so that actuator 34 does not unlock man door 33 automatically, for example, where the garage is a separate structure from the dwelling and unlocking the man door prematurely would leave the dwelling unsecured. In this case, the user unlocks the man door once reaching the dwelling by sending a command from the user device 30, by operating keypad 38, or by using a mechanical key.

According to another embodiment, when a user exits the dwelling through man door 33 and signals controller 22 to open garage door 18 and then closes garage door 18 after exiting the garage with the vehicle, controller 22 causes actuator 34 to lock man door 33. Again, a user-programable delay may be provided between closing door 18 and locking man door 33. According to a further embodiment, instead of controlling actuators 34, 36, 36′ in conjunction with operation of door 18, actuators are controlled separately, for example, based on commands entered via the user device 30. For example, if a user becomes aware that a storm is approaching the dwelling, the user can send a command using device 30 from a remote location to actuate the wind load bolt locks 36′. According to a further embodiment, user device 30 may be programmed to monitor a weather forecast service and actuate the wind load bolt locks automatically. According to another embodiment, the operation of lock actuators 34, 36, 36′ in relation to the operation of door 18 is determined by programmed user instructions.

While illustrative embodiments of the disclosure have been described and illustrated above, it should be understood that these are exemplary of the disclosure and are not to be considered as limiting. Additions, deletions, substitutions, and other modifications can be made without departing from the spirit or scope of the disclosure. Accordingly, the disclosure is not to be considered as limited by the foregoing description.

1. A door operator comprising:
a motor;
a traction mechanism connected with the motor;
a door connected with the traction mechanism, wherein operation of the motor causes the traction mechanism to open and/or close the door and wherein the door is located in a doorway;
a controller operatively connected with the motor to open and close the door;
an imaging system connected with the controller and positioned to collect image data; and
a communication system connected with the controller, the communication system adapted to send data, including image data, from the controller and to communicate command signals to the controller, wherein image data is sent to a remote user device and command signals are received from the remote user device.

2. The operator of claim 1, wherein the image data is a video stream of the doorway.

3. The operator of claim 1, wherein the imaging system comprises two or more cameras.

4. The operator of claim 1, wherein the controller detects that the door is fully open and fully closed and wherein, when a command to open or close the door is received by the communication system, a video stream of the doorway is communicated to the user until the door reaches a fully open or fully closed position.

5. The operator of claim 1, wherein the controller determines, based on the image data, that the door is in a damaged state and does not operate the motor.

6. The operator of claim 1, wherein the imaging system includes a camera positioned to capture an image of objects outside the doorway.

7. The operator of claim 1, further comprising a housing surrounding the motor.

8. The operator of claim 7, wherein the imaging system comprises a camera physically mounted on the housing.

9. The operator of claim 1, wherein the imaging system comprises a camera mounted on a wall.

10. The operator of claim 1, further comprising a presence detector for detecting the presence of a person or vehicle proximate to the doorway and wherein the controller sends a signal to the user in response to a signal from the presence detector.

11. A door operator system comprising:
a door operator comprising:
a motor;
a traction mechanism connected with the motor;
a door connected with the traction mechanism, wherein operation of the motor causes the traction mechanism to open and/or close the door and wherein the door is located in a doorway;
a controller operatively connected with the motor to open and close the door;
an imaging system connected with the controller and positioned to collect one or more images of a region proximate to the doorway; and
a communication system connected with the controller, the communication system adapted to send data from the controller and to communicate command signals to the controller,
wherein the data includes the image, and wherein the data is sent to a remote user and one or more command signals are received from the remote user; and
a remote user device, the remote user device receiving the data and sending the command signals to the operator.

12. The system of claim 11, wherein the imaging system includes a plurality of cameras and wherein the images are video data streams.

13. The system of claim 12, wherein the video streams are communicated to the remote user device via the communication system.

14. The system of claim 11, wherein the controller is operatively connected with one or more remote lock actuators and where a first lock actuator is adapted to actuate a lock on the door to lock or unlock the door.

15. The system of claim 14, further comprising a man door, the man door comprising a man door lock and a second lock actuator operatively connected with the controller, wherein a signal from the controller causes the second lock actuator to lock or unlock the man door lock.

16. The system of claim 15, wherein the images include an image of the man door.

17. The system of claim 11, further comprising a presence detector for detecting the presence of a person or vehicle proximate to the doorway and wherein the controller sends a signal to the user in response to a signal from the presence detector.

18. The system of claim 11, wherein the data includes an image of a credential document, the credential document being associated with an authorized person, and wherein the controller opens the door in response to the image of the credential document.

19. The system of claim 18, wherein the remote user device communicates an authorization time period to the controller, and wherein the controller opens the door in response to the image of the credential document only within the authorization time period.

20. The system of claim 18, wherein after the controller opens the door the controller waits for a delay period and then closes the door.
